(19) United States
(12) Patent Application Publication
(10) Pub. No.: US 2025/0003627 A1
(43) Pub. Date: Jan. 2, 2025

(54) BUILDING SERVICES SYSTEM

(71) Applicant: Viessmann Climate Solutions SE, Allendorf (DE)

(72) Inventor: Marco GRIESE, Bad Arolsen (DE)

(73) Assignee: Viessmann Climate Solutions SE, Allendorf (DE)

(21) Appl. No.: 18/709,106

(22) PCT Filed: Nov. 24, 2022
(86) PCT No.: PCT/DE2022/100878

§ 371 Date: May 10, 2024

(30) Foreign Application Priority Data
Nov. 26, 2021 (DE) 10 2021 131 043.1

(51) Int. Cl. F24F 12/00; B60L 53/302; F24F 7/08; H01M 10/48; H01M 10/613; H01M 10/615; H01M 10/627; H01M 10/63; H01M 10/6561; H01M 10/66

(52) U.S. Cl. CPC F24F 12/00; B60L 53/302; F24F 7/08; H01M 10/486; H01M 10/613; H01M 10/615; H01M 10/627; H01M 10/63; H01M 10/6561; H01M 10/66; H01M 2220/10

(57) ABSTRACT

A building services system includes a ventilation device for ventilating a building and an electrotechnical device for supplying power optionally to the building or to a vehicle. The ventilation device and the electrotechnical device are designed to be connected to each other via an air guide device in order to control their temperature.

The invention relates to a building services system according to the preamble of claim 1.

A building services system of the type mentioned in the introduction is generally known—in particular in newer buildings with ventilation and photovoltaic systems, for example, so that in this regard it does not require any particular printed evidence. Such a system consists of a ventilation device for ventilating a building and an electrotechnical device for supplying power optionally to the building or a vehicle.

The object of the invention is to improve a building services system of the type mentioned in the introduction. In particular, a temperature control of the electrotechnical device which is as efficient and cost-effective as possible is intended to be provided.

This object is achieved by a building services system of the type mentioned in the introduction by the features set forth in the characterizing part of claim 1.

According to the invention, it is thus provided that the ventilation device and the electrotechnical device are designed to be connected to each other via an air guide device in order to control their temperature (i.e. in order to control the temperature of the electrotechnical device).

In other words, the building services system according to the invention is characterized in that the temperature control of the electrotechnical device is carried out by means of the air guide device connected to the ventilation device.

Other advantageous developments of the building services system according to the invention are found in the dependent claims.

For the sake of completeness, reference is also made to the document DE 20 2017 105 468 U1. While a ventilation device or ventilation system is mentioned in paragraph and battery compartments are mentioned in paragraph the approach according to the invention is not disclosed, namely to control the temperature of an electrotechnical device by a ventilation device.

The building services system according to the invention, including its advantageous developments according to the dependent claims, is explained in more detail hereinafter with reference to the graphic representation of two exemplary embodiments.

In the drawings, schematically

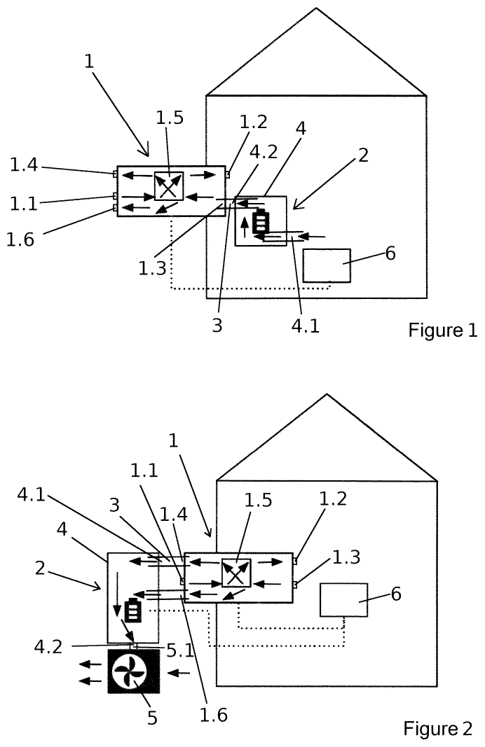

FIG. 1 shows a first embodiment of the building services system according to the invention with an electrotechnical device which is arranged in the building and which is designed as a rechargeable battery; and

FIG. 2 shows a second embodiment of the building services system according to the invention with an electrotechnical device which is arranged outside the building and which is also designed as a rechargeable battery.

The building services system according to the invention shown in the figures firstly consists in the known manner of a ventilation device 1 for ventilating a building and an electrotechnical device 2 for supplying power optionally to the building or a vehicle.

Expressed more specifically, it is particularly preferably provided that the electrotechnical device 2 is designed optionally as a rechargeable battery for the building—as shown in the figures—or as a charging station—not shown separately—in particular as a so-called wall box, for the electric vehicle.

Moreover, it is also provided in a manner known per se that the ventilation device 1 has an external air connection 1.1, a feed air connection 1.2, an exhaust air connection 1.3 and an output air connection 1.4. Fresh air flows from outside via the external air connection 1.1 into the ventilation device 1. The air coming from the external air connection 1.1 flows via the feed air connection 1.2 into the building. Stale air flows from the building via the exhaust air connection 1.3 into the ventilation device 1.1 and therefrom via the output air connection 1.4 into the surroundings of the building.

In order to be able to use a heat recovery system when ventilating the building, it is also preferably provided, in a manner also known per se, that the ventilation device 1 has a heat exchanger 1.5 which is connected to the external air connection 1.1, the feed air connection 1.2, the exhaust air connection 1.3 and the output air connection 1.4, in particular a so-called cross-flow heat exchanger.

In order to be able to switch off a heat recovery system as required, it is also preferably provided that the ventilation device 1 has a bypass connection 1.6 which is directly connected to the exhaust air connection 1.3, bypassing the heat exchanger 1.5.

It is thus essential for the building services system according to the invention that the ventilation device 1 and the electrotechnical device 2 are designed to be connected to each other via an air guide device 3, for example a preferably heat-insulated pipe or preferably heat-insulated duct, in order to control their temperature.

As already explained in the introduction, expressed in terms of the method, it is thus possible that the electrotechnical device 2 is cooled or heated by air which is optionally conducted through the air guide device 3 before or after contact with the electrotechnical device 2.

In this context, it is preferably provided that the electrotechnical device 2 is designed to be provided with a temperature sensor (not shown separately). Preferably, a control device 6, which is connected to the ventilation device 1 and the temperature sensor, is also provided. Expressed in terms of the method, it is also preferably provided that the ventilation device 1 is controlled so as to be oriented to a temperature of the electrotechnical device 2.

In order to be able to deflect the temperature-controlled air flow effectively around the electrotechnical device 2, it is also preferably provided that this electrotechnical device is arranged in a housing 4 with an air supply connection 4.1 and with an air discharge connection 4.2.

With reference to the first embodiment according to FIG. 1, it is particularly preferably provided that the electrotechnical device 2 is arranged in the building.

It is also preferably provided that the air supply connection 4.1 of the housing 4 of the electrotechnical device 2 is designed to open out inside the building. In this embodiment, it is also preferably provided that the air discharge connection 4.2 of the housing 4 of the electrotechnical device 2 is designed to be connected to the exhaust air connection 1.3 of the ventilation device 1.

As can be seen in this embodiment, therefore, the air initially flows out of the building through the housing 4, controls the temperature of the electrotechnical device 2 therein, then flows via the exhaust air connection 1.3 to the ventilation device 1 and optionally therefrom via the output air connection 1.4 or via the bypass connection 1.6 into the open air. The extent of the temperature control of the electrotechnical device 2, as can be seen, can be controlled via controlling the output of the ventilation device 1.

With reference to the second embodiment according to FIG. 2, alternatively it is particularly preferably provided that the electrotechnical device 2 is arranged outside the building.

It is particularly preferably provided here that the air supply connection 4.1 of the housing 4 the of electrotechnical device 2 is designed to be connected (at least) to the output air connection 1.4 of the ventilation device 1. As shown, however, it can also further preferably be provided that the air supply connection 4.1 of the housing 4 of the electrotechnical device 2 (shown here duplicated or twice for the sake of simplicity) is also designed to be connected to the bypass connection 1.6 of the ventilation device 1 already mentioned above.

Moreover, for the further use of the heat it is quite particularly preferably provided that the air discharge connection 4.2 of the housing 4 is designed to be connected to an air inlet connection 5.1 of an evaporator 5 of a heat pump, in particular a so-called air-water heat pump. The housing 4 is arranged optionally adjacent to the evaporator 5 (not shown separately) or above the evaporator 5 (see FIG. 2).

As can be seen, in this embodiment the air coming from the ventilation device 1 flows via the output air connection 1.4 or the bypass connection 1.6 to the air supply connection 4.1 of the housing 4. Once it has arrived there, the air serves for controlling the temperature of the electrotechnical device 2. Then the air flows via the air discharge connection 4.2 and via the air inlet connection 5.1 to the evaporator 5 of the heat pump, where heat can be removed again therefrom if required.

### LIST OF REFERENCE SIGNS

1 Ventilation device
1.1 External air connection
1.2 Feed air connection
1.3 Exhaust air connection
1.4 Output air connection
1.5 Heat exchanger
1.6 Bypass connection
2 Electrotechnical device
3 Air guide device
4 Housing
4.1 Air supply connection
4.2 Air discharge connection
5 Evaporator
5.1 Air inlet connection
6 Control device

1. A building services system, comprising a ventilation device (1) for ventilating a building and an electrotechnical device (2) for supplying power optionally to the building or to a vehicle, wherein the ventilation device (1) has an external air connection (1.1) and a feed air connection (1.2) and wherein air coming from the external air connection (1.1) flows via the feed air connection (1.2) into the building,
wherein
the ventilation device (1) and the electrotechnical device (2) are designed to be connected to each other via an air guide device (3) in order to control their temperature.

2. The building services system according to claim 1,
wherein
the electrotechnical device (2) is designed optionally as a rechargeable battery for the building or as a charging station for the vehicle.

3. The building services system according to claim 1,
wherein
the electrotechnical device (2) is arranged in a housing (4) with an air supply connection (4.1) and with an air discharge connection (4.2).

4. The building services system according to claim 1,
wherein
the electrotechnical device (2) is arranged in the building.

5. The building services system according to claim 3,
wherein
the air supply connection (4.1) of the housing (4) of the electrotechnical device (2) is designed to open out inside the building.

6. The building services system according to claim 3, wherein the ventilation device (1) has an external air connection (1.1), a feed air connection (1.2), an exhaust air connection (1.3) and an output air connection (1.4),
wherein
the air discharge connection (4.2) of the housing (4) of the electrotechnical device (2) is designed to be connected to the exhaust air connection (1.3) of the ventilation device (1).

7. The building services system according to claim 1,
wherein
the electrotechnical device (2) is arranged outside the building.

8. The building services system according to claim 7, wherein the ventilation device (1) has an external air connection (1.1), a feed air connection (1.2), an exhaust air connection (1.3) and an output air connection (1.4),
wherein
the air supply connection (4.1) of the housing (4) of the electrotechnical device (2) is designed to be connected to the output air connection (1.4) of the ventilation device (1).

9. The building services system according to claim 3,
wherein
the air discharge connection (4.2) of the housing (4) is designed to be connected to an air inlet connection (5.1) of an evaporator (5) of a heat pump.

10. The building services system according to claim 9,
wherein
the housing (4) is arranged optionally adjacent to the evaporator (5) or above the evaporator (5).

11. The building services system according to claim 1,
wherein
the electrotechnical device (2) is designed to be provided with a temperature sensor.

12. The building services system according to claim 11,
wherein
a control device (6), which is connected to the ventilation device (1) and the temperature sensor, is provided.

13. A method for operating the building services system according to claim 1,
wherein
the electrotechnical device (2) is cooled or heated by air which is optionally conducted through the ventilation device (3) before or after contact with the electrotechnical device (2).

14. The method according to claim 13,
wherein
the ventilation device (1) is controlled so as to be oriented to a temperature of the electrotechnical device (2).
